(19) United States
(12) Patent Application Publication
(10) Pub. No.: US 2017/0142082 A1
(43) Pub. Date: May 18, 2017

(54) SYSTEM AND METHOD FOR SECURE DEPOSIT AND RECOVERY OF SECRET DATA

(71) Applicant: Sengi Corporation, Aurora (CA)

(72) Inventor: Xiaoyan Qian, Aurora (CA)

(21) Appl. No.: 15/123,346

(22) PCT Filed: Mar. 10, 2015
(86) PCT No.: PCT/CA2015/000149

§ 371 Date: Sep. 2, 2016

Related U.S. Application Data
(60) Provisional application No. 61/950,750, filed on Mar. 10, 2014.
(60) Provisional application No. 61/954,830, filed on Mar. 18, 2014.

(51) Int. Cl. H04L 29/06

(52) U.S. Cl. CPC H04L 63/061; H04L 63/0435; H04L 63/083; H04L 63/0442

(57) ABSTRACT

A system and method are disclosed for providing secure deposit and recovery of secret data based on a secret of a user, such as a password, a shared secret from a recovery server, and a secret from a recovery peer. The secret data is encrypted with these three secrets and stored remote from the user device to only allow the user to recover the secret data without compromising the secrecy of the secret data. Systems and methods for decoupling a password from the secret data the password protects is also provided to allow resetting the password or recovering the secret data to be separate operations that can be carried out independently. Another aspect provides for a user account to be securely recovered using a recovery peer to verify ownership of the user account.

### FIELD

The present disclosure relates generally to cryptographic systems and methods to allow for secure deposit and recovery of secret data. More particularly, the disclosure relates to cryptographic systems and methods that use encryption to provide data security and access control on distributed data across communication networks such as the internet.

### BACKGROUND

With the increasing use of the internet, more and more users and businesses turn to web-based services for email, file storage, data sharing, social networking and other applications. These web-based services all involve storing and exchanging large amount of sensitive data over the internet. They largely rely on the service providers to protect their data, which we refer to as the trusted-third party model.

The trusted-third party model relies on the good faith and competency of web service providers to protect the users' data. Users have to trust the service providers to properly protect their data with good intention and the users' essentially lose control over who can access their data. The users' data are not only vulnerable to external and insider attacks, but they are also subject to high risks and potential abuses. Furthermore, these service providers have different access control approaches driven by different needs or technologies. Therefore the access controls of the end users' data in different environments are highly fragmented.

The alternative to the trusted third party model is the use of end-to-end encryption model. This model shifts the responsibility of data security and access back to the end user but also the liability of securely protecting the encryption key from loss or theft. If a user loses an encryption key then the secured data will no longer be available. Similarly, if the encryption key is compromised or stolen then the data may no longer be secure.

Shifting the key management responsibility to the users causes many usability issues, such as exchanging encryption keys and securely and reliably storing encryption keys. Some approaches try to resolve these issues by combining the end-to-end encryption model and the trusted-third party model by having a the user trust a third party to manage and secure their encryption keys used in an end-to-end encryption model. These combined approaches still suffer from the same issues as the trusted-third party model as the users' secured data may be accessed by the trusted third party or by compromising the security of the trusted third party.

In typical database systems such as relational database management systems (RDBMS), there are access control systems in place to selectively authorize access to data objects based on a user account or role or group in terms of access privileges. Such an access control system typically functions as a part of a closed system. It depends on the metadata to decide who can access what data. For distributed data residing in separated systems, such conventional access control system cannot function. With the internet increasingly being used as both information storage and transfer media, user data are typically distributed across multiple different and independent web sites or services. Therefore such a conventional access control system cannot function. Moreover, such a conventional access control system depends on database administrators to manage, such as granting or revoking, the access rights. From an end user perspective, such an approach is essentially the same as trusting a 3rd party, which has no assurance of data confidentiality.

Cryptography systems have intrinsic access control properties in a distributed setting such as the internet. Anyone who can access a cipher doesn't necessarily mean that he/she can access the original data of the cipher. Only the intended users who possess the keys that can decrypt a cipher can access the data. Among many cryptography systems, client-based end-to-end cryptography systems, such as PGP and SMIME, offer strong data security assurance for end users.

However, many issues prevent these systems from being used as common access control tools for average users to govern their sensitive data distributed all over the internet. First, these systems are not sufficient for access control. Because once the data are encrypted and distributed such as after a PGP or SMIME email being sent, it's difficult to grant additional access or revoke an existing access. Second, the key managements of such systems are enormously hard for most average users. Third, the fact that users have to exchange public key certificates before exchanging any data further deter users from adopting them. Furthermore, once the private key is lost, the data protected by the private key cannot be recovered. This is a big risk for users who consider adopting the systems. Especially, with the increasing use of mobile devices among users, losing a mobile device is an event with high probability. Losing a mobile device with its stored secret key, such as a private PGP key, is a major risk for a user of such end-to-end cryptography systems.

Various systems have been proposed to address some of the issues. To prevent the loss of a private key, a common solution is to allow a user to encrypt a private key with a passphrase then store the encrypted private key in systems accessible over the internet. As long as users have access to the systems, the users can retrieve the private key ciphers and decrypt them by inputting the passphrases. However, users of such systems have to shoulder the burden of remembering the passphrases. Losing the passphrases results in losing the encrypted private keys. They are vulnerable to either losing the private keys when forgetting complex passphrases or vulnerable to being attacked when using simple passphrases even in the case of using password-based key derivation function (KDF). In addition, it is a one-factor authentication because knowing the passphrase can get the private key to decrypt the data. More importantly, data protected by a user passphrase is vulnerable to systematic insider attacks by the server.

A system described in US 2013/0198508 A1 allows a local device to recover an encrypted key that is encrypted by a key, L, related to two “public” keys, one of which D is stored in the local device. This is useful when a user cannot recall the password for a password-encrypted version of the encrypted key. However, when the local device is lost and the stored “public” key D is also lost, L cannot be recovered. Thus the encrypted key cannot be recovered.

Some systems, such as Symantec PGP products or a system described in US 2013/0080765 A1, require extra secrecies for recovery purpose. For example, multiple personal questions and answers known to a user are used to create a recovery key. However, because recovery is not a frequent event, answers to these questions could be very hard to remember. In fact, these systems force a user to remember more secrecy.

Some systems distribute recovery secrecy to multiple systems such as different sites in parts so that in the case of recovery the segments of data are retrieved from these sites and combined together to recover the data. For example, a system described in U.S. Pat. No. 8,572,757 B1 stores a recovery key in one site and the encrypted data in another site. These systems are cryptographically unsafe because it requires a user to turn over the secrecy to a trusted 3rd party. Such systems are vulnerable to large scale systematic collusion attacks.

### SUMMARY

According to a first aspect, a social-based cryptographic system is provided for secure deposit of a secret data associated with a user account, the system comprises a user device, a recovery server, and a recovery peer. The user device has a memory for storing instructions and a processor for executing the instructions to derive an encryption key based on a secret provided to the user device to generate a derived encryption key, encrypt the secret data using the derived encryption key to generate a once-encrypted secret data, designate a recovery peer and obtaining a recovery-peer key associated with the recovery peer, and encrypting the once-encrypted secret data using the recovery-peer key to generate a twice-encrypted secret data. The recovery server stores the twice-encrypted secret data and associates the twice-encrypted secret data with the user account and the recovery peer. The recovery peer device associated with the recovery peer, the recovery peer device having a memory for storing instructions and a processor for executing the instructions to: generate the recovery-peer key and provide the recovery-peer key to the user device. In some aspects of the social-based cryptographic system the secret data associated with the user account can be securely recovered, the recovery peer device having further instructions to obtain the twice-encrypted secret data, decrypt the twice-encrypted secret data using the recovery-peer key to recover the once-encrypted secret data, and transmit the once-encrypted secret data to the user device; and the user device having further instructions to derive the encryption key based on a secret provided to the user device to generate the derived encryption key at the user device, and decrypt the once-encrypted secret data using the derived key to recover the secret data.

According to a second aspect, a method for depositing a secret data of a user account in a cryptographic system to allow for secure recovery of the secret data is provided. The method comprises deriving an encryption key based on a secret provided to a user device to generate a derived encryption key at the user device; designating a recovery peer and obtaining a recovery-peer key associated with the recovery peer; encrypting the secret data using the derived encryption key and the recovery-peer key to generate an encrypted secret data; and storing the encrypted secret data at a location remote from the user device. In some embodiments encrypting the secret data can comprise encrypting the secret data using the derived encryption key to generate a once-encrypted secret data, and encrypting the once-encrypted secret data using the recovery-peer key to generate a twice-encrypted secret data. In a further aspect of the method for securely depositing secret data the secret can be a password and deriving the derived encryption key can use a password-based key derivation algorithm at the user device. The password-based key derivation algorithm can use any one of a salt, an iteration count, and a combination thereof obtained from the recovery server. In a further aspect of the method for securely depositing secret data can include obtaining a symmetric key from the recovery server associated with the user account, and the derived encryption key can be comprised of the symmetric key and a key derived from a password-based key derivation algorithm using a password. The derived encryption key can be comprised of the XOR operation of the symmetric key and the key derived from a password-based key derivation algorithm using the password.

In a further aspect of the method for securely depositing secret data, the recovery-peer key can be a public key corresponding to a public/private key pair associated with the recovery peer or a symmetric key shared with the recovery peer. The recovery-peer key can be obtained from the recovery server. In a further aspect the recovery peer and the user account can have mutually consented to provide secure recovery to one or each other. In a further aspect of the method for securely depositing secret data, the location remote from the user device can be the recovery peer or the recovery server. The recovery server can associate the encrypted secret data with the user account and the recovery peer.

In yet a further aspect of the method for securely depositing secret data, the twice-encrypted secret data can be cryptographically signing with an identity key associated with the user account. In yet another aspect the secret data can be a private key corresponding to a public/private key pair associated with the user account.

According to a third aspect, a method for securely recovering a secret data of a user account in a cryptographic system that has been securely deposited is provided. The method for securely recovering a secret data comprises obtaining an encrypted secret data at a recovery peer device, the encrypted secret data encrypted using a derived encryption key based on a secret and a recovery-peer key of a recovery peer device; deriving an encryption key based on a secret provided to the user device to generate the derived encryption key at the user device; decrypting the encrypted secret data using the recovery-peer key and the derived encryption at the user device to recover the secret data.

In some aspects of method for securely recovering the secret data, the step of decrypting the secret data can comprise decrypting the encrypted secret data by the recovery peer device using the recovery-peer key to generate a once-encrypted secret data; receiving the once-encrypted secret data from the recovery peer device at a user device associated with the user account; and decrypting the once-encrypted secret data using the derived key to recover the secret data. The secret can be a password and deriving the derived encryption key uses a password-based key derivation algorithm at the user device. The user device can obtain a salt, an iteration count, or a combination thereof, from the recovery server that can be used as an input to the password-based key derivation algorithm. In some aspects, a symmetric key associated with the user account can be obtained from the recovery server, and the derived encryption key can be comprised of the symmetric key and a key derived from a password-based key derivation algorithm using a password. The derived encryption key can also be comprised of the XOR operation of the symmetric key and the key derived from a password-based key derivation algorithm using the password. An authentication token can be provided to the recovery server from the user device to verify that the user account is associated with the user device, the authentication token can be generated from a password using the password-based key derivation algorithm at the user device

In some further aspects of method for securely recovering the secret data, the method can further comprise receiving a request for secret data recovery from a user device at a recovery server; and identifying a recovery peer. The method can also include transmitting the twice-encrypted secret data to the recovery peer from the recovery server.

In still other aspects of method for securely recovering the secret data, the recovery-peer key can be a private key stored on the recovery peer device corresponding to a public/private key pair of the recovery device. The method can also comprise receiving a confirmation associated with the user account through an out-of-band communication that the user account is requesting recovery of the secret data. The out-of-band communication can include a cryptographic hash, such as fingerprint, associated with a communication channel, or a public/private key pair that is used to secure the communication channel, used by the user device to request secure recovering of the secret data. In some aspects the secret data can be a private key corresponding to a public/private key pair associated with the user account, such as to identify the user account.

According to a fourth aspect, a method of securely recovering a user account without a password using peer-based authentication of ownership of the user account is provided. The method comprises generating a random value at a user device associated with the user account and cryptographically signing the random value with a user private key associated with the user account to generate a first signature; designating a recovery peer and obtaining a recovery key associated with the recovery peer; encrypting the first signature with the recovery key associated with the recovery peer to generate an encrypted first signature; storing the random value and the encrypted first signature at a recovery server; retrieving the encrypted first signature from the recovery server at recovery peer device of the recovery peer; decrypting the encrypted first signature using the recovery key at a recovery peer device of the recovery peer to generate decrypted first signature; providing the decrypted first signature to the recovery server; and verifying the decrypted first signature using a user public key corresponding to the user private key and the random value at the recovery server. In some aspects of the method, the recovery key can be a public key and decrypting the encrypted first signature can use a recovery private key corresponding to the public key. In other aspects the recovery key can be a symmetric key. In yet a further aspect, the method can further comprise requesting the recovery peer authenticate ownership of the user account through an out-of-band communication to prevent a man-in-the-middle attack.

In yet another aspect of the method of securely recovering a user account, the method can further comprise generating a new-identity public key and a new-identity private key; associating the new-identity public key with the user account by cryptographically signing the new-identity public key with the recovery public key at the recovery peer device to generate a second signature; and verifying that the second signature belongs to the recovery peer.

According to a fifth aspect, a method of decoupling a password from secret data secured with the password is provided. The method comprises encrypting the secret data with a server key stored at a recovery server; and permitting access to the server key by a user device by authenticated access using the password.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a schematic diagram of a social network-based cryptographic system for providing encryption-based access control and secure recovery of secret data;

FIG. 2 is a flowchart diagram of a method for enforcing access control in the social network-based cryptographic system of FIG. 1;

FIG. 3 is a flowchart diagram of a method for depositing secret data to allow for secure recovery using a recovery peer;

FIG. 4 is a flowchart diagram of a method for securely recovering secret data using a recovery peer device;

FIG. 5 is a flowchart diagram of a method for securely recovering a shared secret between a user and a recovery peer;

FIG. 6 is a flowchart diagram of a method for securely sharing data between peers;

FIG. 7 is a flowchart diagram of a method for setting up a peer-based account recovery; and

FIG. 8 is a flowchart diagram of a method for a peer-based authentication and account recovery.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

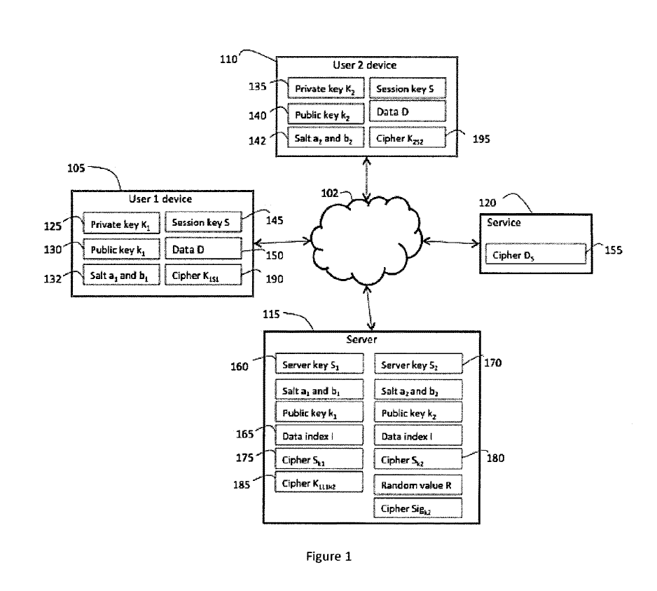

Referring to FIG. 1, a block diagram illustrates an exemplary environment 100 having a first client device 105 of User 1, a second client device 110 of User 2 coupled to a data communication network 102, such as the internet, for example, with a server computer 115 and a service 120.

Client devices 105 and 110, server computer 115 and service 120 are computing devices that include a computer processor and a memory for storing data and software instructions for execution by the processor. These computing devices also include a network interface, wired or wireless, to allow communication using data communication network 102. Devices 105 and 110 can be a mobile phone, a tablet, a wearable device, a computer or any other kind of computing device.

User 1 device 105 is a client device User 1 can register a user account using an identifier and an authentication token, such as a passphrase, for example, with server 115. The identifier can be a unique and arbitrary string or any other unique identifier, such as an email address, for example. Although embodiments below are described using a passphrase, other authentication tokens may be used similarly. The term “user account” is used generically to associate a user of the system and can include physical persons or devices as users. For example, an autonomous device or device in the Internet-of-Things can also have a user account with server 115.

Once the user account is created, the client device generates a private/public key pair of private key K₁ 125 and public key k₁ 130 as master keys. In some embodiments, keys 125 and 130 can be generated based on Elliptic Curve Cryptography (ECC) or any other asymmetric systems including but not limited to, RSA, EIGamal, Diffie-Hellman, Paillier, NTRU and McEliece. User 1 device 105 further generates a server key S₁ 160. User 1 device 105 can then deposit public key k₁ 130, and clear-text server key S₁ 160 into User 1 account stored on server 115, preferably via a secure communication mechanism, such as SSL/TLS, for example, or any other means of secure communication. In some embodiments, server key S₁ 160 can be generated at server computer 115 associated with User 1 account. In these embodiments, server key S₁ 160 is transferred to device 105 via secure communication. It is understood that User 1 is authenticated before accessing server key S₁ 160. In some embodiments, server key S₁ 160 can be encrypted by a key derived from the authentication token and stored locally in device 105, in addition to a copy of the server key S₁ 160 being stored in the server computer 115. User 1 is required to present the passphrase to decrypt the local server key S₁ 160 or login to User 1's account on server 115 to retrieve server key S₁ 160.

User 1 Device 105 encrypts master private key 125 with server key 160 via a symmetric encryption algorithm. Device 105 outputs cipher K_{1S1} 190 and stores cipher K_{1S1} 190 locally on device 105 along with public key k₁ 130. This provides a method of decoupling a password from secret data that is secured with the password by encrypting the secret data with a server key stored at the recovery sever and permitting access to the server key by a user device by authenticated access using the password. The secret data can be a private key stored on the device that is encrypted with the server key.

The decoupling of the login passphrase and the master private key stored in device 105 during normal operations allows resetting passphrase and recovering master private key become two separate operations, which allows each of the operations to be carried out freely and independently. With this decoupling, when losing the User 1 Device 105 that stores the master private key, a login passphrase could help recover the master private key; when resetting a login passphrase, it would not affect the local encrypted master private key. Those skilled in the art will appreciate that this lowers the probability of losing both login passphrase and a device storing the master private key at the same time. Equally important, this decoupling ensures a user is authenticated by two factors in order to access data. One is the login passphrase, which a user knows. The other is the master private key in the device, which a user has.

In a preferred embodiment, the symmetric algorithm can be AES-256 in CTR mode, where server key size is 256 bits in length. Any other symmetric encryption algorithms including block ciphers and stream ciphers such as Blowfish, DES, Triple DES, Serpent, Twofish, IDEA, RC2, RC5, and any key sizes can be used. In some embodiments, device 105 can additionally output and store another cipher locally by encrypting master private key 125 with a derived key based on User 1 account passphrase.

User 1's account passphrase can be enhanced by a password-based key derivation function such as PBKDF2, bcrypt or scrypt. In a preferred embodiment, PBKDF2, salt a₁ and a sufficiently large iteration count can be used to derive a strong passphrase, which is stored in server 115 for authentication purpose. Salt a₁ can be generated by the client device process during key generation.

In some embodiments, User 1's account identifier can be signed by User 1's master private key 130. The signature can then be deposited into User 1's account on server 115.

In the case that User 2 registers a user account in server 115 with a device 110, master private key K₂ 135 is generated, encrypted with generated random server key S₂, and stored locally in device 110 along with generated master pubic key k₂ 140. Public key 140, generated random salts a₂ and b₂ and server key S₂ can all be deposited in registered User 2 account in server 115 via a secure communication channel. It's to be understood that User 2 could be a secondary account of a same physical user.

In a preferred embodiment, User 1 can look up User 2 with necessary contact information or identifier, such as User 2's email address, and initiate a request of exchanging encrypted data with User 2. If User 2 accepts and authorizes the request, User 1 and 2 are allowed to exchange both master public keys k₁ 130 and k₂ 140 with each device. Otherwise, User 1 and 2 will not be allowed to have each other's public keys. In some embodiments, User 1 and 2 can verify associated fingerprints of the public keys or digital signatures signed by each other's master private key when exchanging public keys.

While a user authorized handshake may or may not be used for exchanging public keys, those skilled in the art will appreciate that this helps a recipient easily differentiate the trust level of incoming encrypted data. More importantly, it could also reduce the probability of any unintended or malicious encrypted data being decrypted by a recipient's client device.

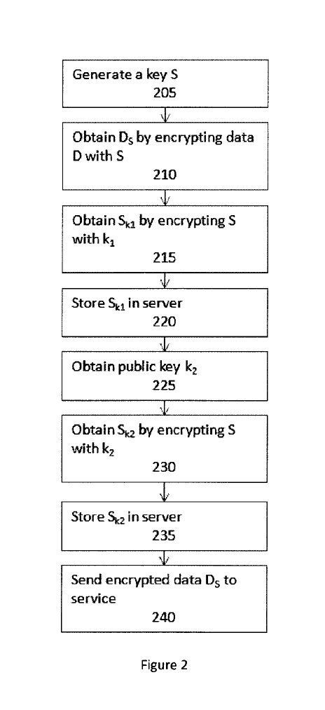

In the case that User 1 needs to send data D, such as a private email, for example, to User 2 via service 120, such as a webmail provider, for example, User 1 device 105 can initiate a process 200 illustrated in FIG. 2. At step 205, device 105 will generate a session key S, then at step 210 encrypt the data D with the session key S (preferably using AES-256 in CTR mode) and output cipher Ds 155. In some embodiments, device 105 can first compress data D, then encrypt the compressed data D and output cipher Ds 115. In some embodiments, the session key can be a random key. In other embodiments, the session key can be generated based on data D. For example, session key S could be a hash value of a file when data D is a file and service 120 is a cloud storage service. Data D authenticity and integrity checking and non-repudiation may or may not add to cipher Ds 155. In some embodiments, device 105 can generate a digital signature for data D using User 1's master private key and associates to cipher 155.

Device 105 can also generate an index I 165 associated to cipher 155. In some embodiments, the index can be inserted into cipher 155. In other embodiments, the index can be derived from cipher 155. At step 215, device 105 will encrypt the session key S with its own public key k₁ and at step 220 deposit output cipher Ski 175 and index I 165 into the account in server 115 associated with User 1. At step 225, User 1 Device 105 can also retrieve User 2's public key k₂ according to User 2's identifier, such as an email address, and at step 230 encrypt the session key S with User 2's public key k₂. At step 235 device 105 deposits the output cipher Sₖ₂ 185 and the associated index I 165 into User 2's account at server 115. Finally, at step 240, User 1 Device 105 sends Ds to service 120.

In a preferred embodiment, device 105 can store a copy of server key encrypted by a key derived from User 1's account passphrase. During normal operation, when User 1 logs into server 115 by using an account identifier and a passphrase, User 1 Device 105 can derive a key based on the input passphrase and obtain server key S₁. With server key S₁, device 105 can decrypts cipher K_{1S1} to obtain master private key K₁ and store it in the device memory for normal operation.

User 2 device 110 can receive or retrieve cipher Dₛ185 from service 120, such as an email from a webmail provider, for example. Device 110 will also retrieve cipher Sₖ₂ 180 from server 115, decrypt cipher 180 with User 2 private key K₂ and obtain session key S 145 locally at User Device 2. Finally with session key S 145, it decrypts cipher Dₛ 155 and obtains data D 150 locally. In some embodiments, device 110 can further uncompress the obtained data after decryption to obtain data D 150. In some embodiments, User 2 device 110 can also validate the digital signature of data D using User 1's master public key.

If User 1 needs to revoke User 2's access to cipher 155, after sending out the private email, or cipher Ds 155 to service 120, User 1 can look up and remove cipher Sₖ₂ 180 from User 2's account stored on server 115.

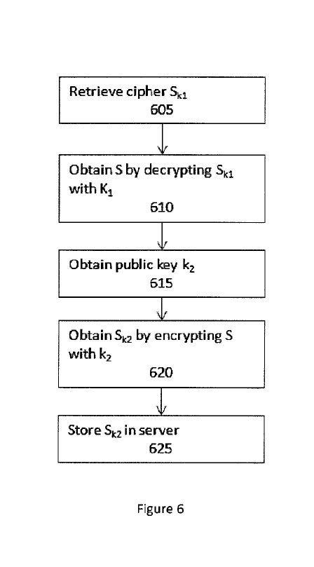

In the case that User 2 has not yet registered an account in the server 115. User 1 can still first exchange data with User 2 before any public key exchange takes place, then at a later time grant additional access right to User 2, after User 2 registers an account in server 115 and performs the public key exchange. In this case, User 1 can first carry out steps 205, 210, 215, 220 and 240. Later, once User 2 has registered an account and a user-authorized handshake took place, User can 1 can perform the process illustrated in FIG. 6 to grant the access right to User 2. At step 605, device 105 retrieves cipher Ski 175, at step 610, obtains session key S 145 by decrypting cipher 175 with key K₁ 125, after obtaining public key k₂ 140 at step 615, encrypts session key 145 with public key 140, outputs cipher Sₖ₂ 180 locally at step 620. Finally device 105 deposits cipher 180 into User 2's account in server 115 at step 625.

It is understood that data D is not limited to be email. It could be any type of files, text and media based on applications. Service 120 is not limited to be a web mail provider. It could a cloud storage service, a social network service, a messaging service or any type of services that temporarily or permanently store and access to cipher 155. Service 120 could be any destination service or intermediate service. Service 120 might or might not have its own access control mechanism. It should also be understood that service 120 not only can reside in the internet, but also can reside with server computer in the same network including, but not limited to, LAN, VLAN, wireless network, WAN and any combination of them.

It should also be understood that it's easy to grant additional access rights to additional users to access cipher Dₛ 155. In the case of User 1 sharing a file, or data D 150, via a cloud storage service, or service 120, after User 1 initially granting access right to User 2 according to block diagram 200, User 1 can still grant an additional access right to an extra user. Device 105 can first retrieve cipher 175 and the associated index I 165, decrypt cipher 175 with private key 125 to obtain session key S 145, then encrypt session key S 145 with the public key of the extra user and deposits output cipher and the index 165 into the extra user's account in the server.

In the case User 1 needs to recover the master private key when the local master private key is lost, for example by losing device 105, User 1 can pick one or more users with whom User 1 has completed handshakes and store the master private key securely in the server computer. In a preferred embodiment, at the same time, User 1 might additionally enable account recovery by storing a secret signature in the server computer for supporting authentication factor “the peer you know”, whose details are described in process 700 and 800.

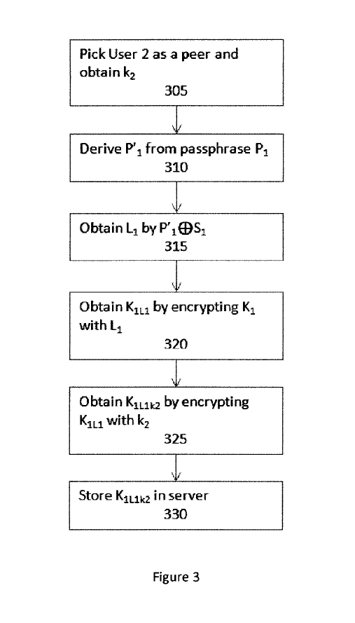

Next reference will be made to FIG. 3 which illustrates a method for depositing secret data to allow for secure recovery using a recovery peer. The secret data in this example refers to the private key 125 of User 1 but any other type of secret data, such as passwords or a file, for example, can be recovered using this method. The server 115 is also referred to as the recovery server as it assists with the secret data recovery.

Illustrated in FIG. 3, process 300 is a process for storing secret digital data securely using recovery peers. At step 305, User 1 pick User 2 as a recovery peer and obtains a recovery-peer key from User 2. In this example, User 2's public key k₂ corresponding to User's 2 private key K₂. User 1 also derives an encryption key based on a secret provided to the user device to generate a derived encryption key. A passphrase P1 can be input by User 1 as the secret for deriving a key P′₁. Such a passphrase can be an arbitrary string with sufficient security strength. In a preferred embodiment, such a passphrase can be identical to the passphrase of User 1 account. At step 310, a key P′₁ is derived from P₁ using a password-based key derivation function, such as function PBKDF2 with salt b₁ and a sufficiently large iteration count c₁. At step 315, another key L₁ can be further derived from derived key P′₁ by combining with server key S₁. In this manner the derived encryption key is a combination of a secret of the user (e.g. the passphrase) and a shared secret with the recovery server 115. In a preferred embodiment, the combining operation can be an XOR operation. At step 320, device 105 encrypts the secret data, or the master private key K₁ 125, with derived key L₁ and outputs cipher K_{1L1}. At step 325, device 105 further encrypts cipher K_{1L1} with the recovery-peer key, (e.g. public key k₂) and outputs cipher K_{1L1k2} locally. Finally, at step 330, device 105 stores cipher K_{1L1k2} at a location remote from User Device 105, such as in recovery server 115 or another internet-accessible server.

The encryption of the secret data can be done in any number of reversible ways using the recovery-peer key and the derived encryption key, such as by changing the order to application of the keys or combining the keys to encrypt the secret data. In some embodiments, the secret data, K₁, can be first encrypted with a derived key from a passphrase, then encrypted with server key S₁ before being encrypted with User 2's public key k₂. In other embodiments, K₁ can be first encrypted with server key S₁, then encrypted with a derived key from a passphrase before being encrypted with User 2's public key k₂. It is to be understood that the re-encryption is not limited to using User 2's public key. In some embodiments, the re-encryption is done using User 2's symmetric key accessible by User 1. In these embodiments, User 1's device can use a symmetric key to encrypt K_{1L1} then transfer and store the symmetric key in User 2's device via secure communication means. In these embodiments, the derived encryption key, L₁, can be generated by combining P′₁, S₁ and the shared symmetric key of User 2. K_{1L1} is generated by encrypting with L₁ and stored in server. In other embodiments, User 1's device can use a shared symmetric key associated with the public keys of User 1 and User 2 to obtain K_{1L1}, for example, based on Elliptic Curve Integrated Encryption Scheme (ECIES).

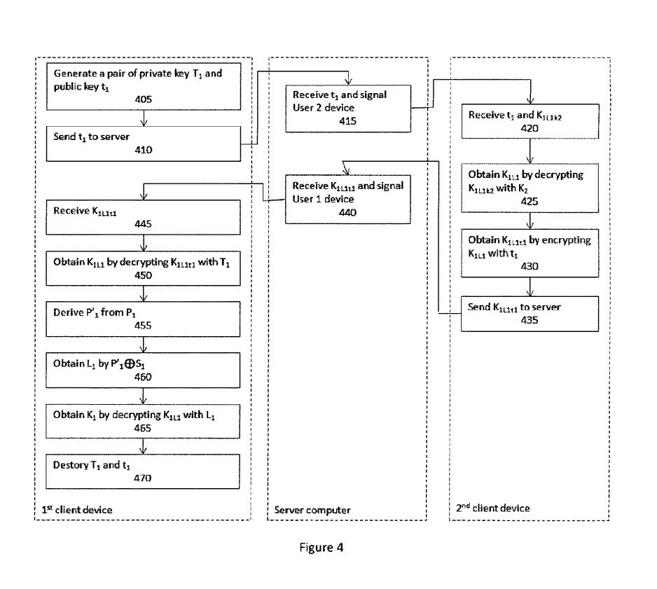

In the case of losing master private key 125 and cipher 190 (or registering a new User Device associated with the user account stored at the recovery server), after User 1 has logged in into his account by providing the passphrase, and optionally verifying with one or more additional authentication factors, device 105 can initiate a master private key recovery process illustrated in FIG. 4. At step 405, device 105 generates a pair of private key T₁ and public key t₁, then at step 410 sends public key t₁ to server.

At step 415, server 115 receives t₁ and signals User 2 device 110 to help recover private key for User 1.

At step 420, device 110 receives public key t₁ and cipher K_{1L1k2} 185. The cipher K_{1L1k2} 185 is provided as an example of encrypted secret data that can be decrypted to recover the secret data using a derived encryption key (derived from a secret of the user and a shared secret with the server) and a recovery-peer key.

In a preferred embodiment, upon receiving public key t₁ and the recovery request, User 1 and User 2 carry out a public key verification on t₁, via an out-of-band communication, at the same time allow User 2 to authenticate User 1 is the person who issues t₁. An out-of-band communication can refer to any communication between User 1 and User 2 that verifies the identity of the other user to ensure that it is the User that is making the request. This can include digital communication, such as e-mail, SMS text messages, and non-digital communication such as in person communication or phone calls.

Any approach of verifying a public key during exchange known in the art can be used, for example, verifying the fingerprint of a public key or a digital signature. The fingerprint can be provided by an SMS message, for example, from User 1 to User 2. Such verification can detect a potential man-in-the-middle attack. At step 425, device 110 decrypts K_{1L1k2} with the recovery-peer key of User 2 (e.g. private key K₂) and obtains cipher K_{1L1}. In some embodiments, device 110 can obtains cipher K_{1L1} by using a symmetric key. At step 430, device 110 encrypts cipher K_{1L1} with public key t₁ and output cipher K_{1L1t1}. At step 435, device 110 sends cipher K_{1L1t1} to recovery server 115.

At step 440, recovery server 115 receives cipher K_{1L1t1} and notifies device 105.

At step 445, device 105 receives cipher K_{1L1t1}, and at step 450 decrypts it with private key T₁ and obtains cipher K_{1L1}. Next, device 105 derives an encryption key based on a secret provided to User Device 1 (e.g. a passphrase or biometric) and a shared secret with the recovery server 115. At step 455, device 105 derives key P′₁ from passphrase P₁ using the same password-based key derivation function with the same parameters as used in step 310 to deposit the secret data for secure recovery. In a preferred embodiment, passphrase P₁ can be read from the memory location where P₁ is stored after being input by User 1 during log in. In other embodiments, passphrase P₁ can be being input by User 1 explicitly. At step 460, device 105 further derives key L₁ by combining P′₁ and retrieved server key S₁. The combining operation is identical to the one at step 315. Once key L₁ is recovered, at step 465, device 105 decrypts cipher K_{1L1} with key L₁ and obtains master private key K₁. Finally, at step 470, device 105 can destroy private key T₁ and public t₁.

It's to be understood that the recovered digital data could be any digital data other than the master private key K₁. It could be also any types of files including, but not limited to, documents, images, binaries, hard drive images and backup files. In some embodiments, the master private key K₁ can be encrypted with more than one recovery peers' public keys.

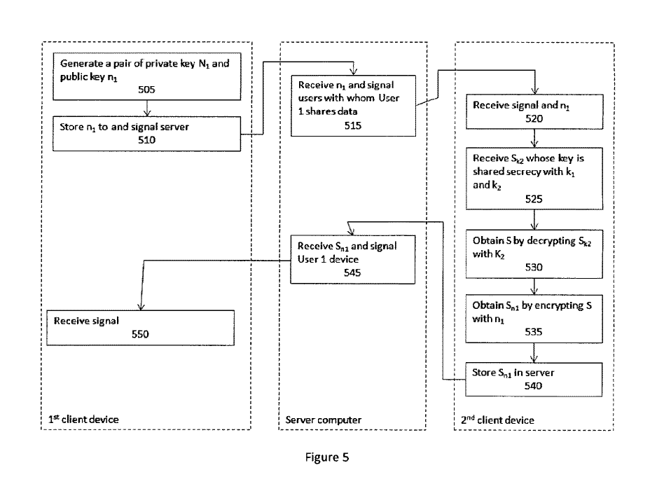

In a case of User 1 not being able to remember account passphrase as well as losing master private key 125 in device 105, access to the data shared by peers can remain recoverable. After User 1 completed an authentication with one or more factors, for example, at least one of them is the factor described in process 700 and 800. User 1 can re-login into User 1's account at server 115 and initiate a restore data access process illustrated in FIG. 5 to recover a shared secret (e.g. cipher Dₛ 155) between User 1 and User 2.

At step 505, device 105 generates a new pair of master private key N₁ and master public key n₁. At step 510, device 105 stores public key n₁ to server 115.

At step 515, server 115 receives public key n₁ and signal of restoring data access. Server 115 identifies all users with whom User 1 share data and signal found users, User 2 in this example.

At step 520, User 2 device 110 receives a signal from server 115 and retrieves new public key n₁. At step 525, device 110 retrieves cipher, Sₖ₂, whose key is shared secrecy with public key k₁ and k₂. At step 530, for each retrieved cipher, Sₖ₂, device 110 decrypts Sₖ₂ with master private key K₂ and obtain session key S. At step 535, for each obtained session key S, device 110 encrypts S with new public key n₁ and outputs cipher Sₙ₁. At step 540, device 110 stores cipher Sₙ₁ in server 115.

At step 545, server 115 receives and store cipher Sₙ₁ and signals User 1 that the recovery process by User 2 is completed.

At step 550 device 105 receives signal of completion and ready to access recovered data with new master private key N₁.

In the case that User 1 cannot remember the account passphrase, a passphrase reset can be initiated. User 1 should first be authenticated with one or more factors. In some embodiments, User 1 can be authenticated with two factors by verifying an email and verifying a text message. It's to be understood that the authentication mechanism could be any approach known in the art. Once User 1 is authenticated, device 105 can retrieve server key S₁ from server 115 and decrypt cipher K_{1S1} to obtain K₁. Device 105 thus can replace the local encrypted copy of server key S₁ cipher K_{1S1} by encrypting S_{K1} with the new passphrase, in a preferred embodiment, as well as replace cipher K_{1L1k2} by initiating the peer-based recovery illustrated in block diagram 300, using the new passphrase. It is to be understood that the passphrase for authentication could be a separate passphrase for encrypting secrecies and they could be a single passphrase. It is also understood that a user account could be authenticated with different authentication tokens, such as smart cards, one-time passwords, images, biometrics as well as a passphrase could be a sequence of bits derived from such mechanisms.

Those skilled in the art will appreciate that the present disclosure significantly strengthens data security and recoverability of online data for a user and the usability of cryptography systems, by using social peers. Intuitively, a group of users can better defend attacks than an individual. By helping each other, a user can keep online data safe by only using a passphrase. This allows social groups more than just for sharing but also for better protection, recovery and usability, thus becomes a social security network. It maintains strong data security assurance on a secrecy stored in the server based on the strength of cryptographic elements. It first resists insider attacks from the server using a multi-layer encryption. It also resists attacks by a recovery peer by wrapping the secrecy with a generated key. A vicious recovery peer has to try login interactively to brute force the passphrase in order to get the server key. Such attempts are not sufficient and can be detected easily by the server. In the case of a recovery peer colluding with the server together, the secrecy is still protected by the strength of a user passphrase and the key derivation functions. The requirement of collusion with an individual prevents large-scale attacks especially when the server is comprised. Because a recovery peer is likely a trusted person of the user, it is less likely for a collusion to take place. In addition, the availability of both passphrase reset and recovery solution allows a user to pick a stronger passphrase, as the user knows that the account and data are recoverable in the case of losing a passphrase.

In the case that User 1 account and User 2 account are two different accounts of a same physical user, using User 2 account as a recovery peer also offers significant security benefits. A brute force attack on User 2's account can not directly comprise the security of User 1 account. In some embodiments, a physical user can use two separated accounts, each of which acts as the other's recovery peer. Such a setup can give the same physical user additional recovery means without weakening the strong security assurance.

Those skilled in the art will appreciate that with the combination of features of passphrase reset, key recovery and shared data recovery, the present disclosure significantly reduces the task for a user to manage secrecy without comprising data security assurance. When losing account passphrase, the master private key can be recovered. When losing a device or the storage of the master private key, the master private key can be recovered, without the need of keeping extra secrecy. Even when both passphrase and device with master private key are lost, shared data can still be recovered, which minimizes the lost of data. In addition, to access a user's data, an attacker needs two factors—the passphrase that a user knows and the master private key that a user has. This significantly strengthens the security of user data.

Those skilled in the art will also appreciate that the present disclosure allows multiple client devices to communicate securely without being online at the same time, by storing communication data in an intermediate storage service when client devices are offline. It can enhance the data security for many services including messaging services.

In some environments such as an enterprise environment, it's typically required to access data for audit, virus scan, monitor, or sometimes being recovered by an employer when an employee leaves an organization. In this case, one or more additional access for trusted authorities are optionally granted to targeted encrypted data by automatically adding encrypted session keys associate with the authority account. In some embodiments, such an automatic-granted access could be carried out in a form of attaching the encrypted session key to the targeted encrypted data, i.e. key escrow. In other embodiments, the key escrow can be in a compatible format of PGP, SMIME or other standards. Those skilled in the art will appreciate that such hybrid form of access control it is easy to perform inline data scanning without compromising the flexibility of managing access control with end users. In a preferred embodiment, those user accounts and communications subjected to authority access are differentiated using indicators on the user interface presented on a graphic display of client devices, for example, different colors, fonts or graphical symbols, such that communication peers are aware of what data can be accessed by a 3rd party. Being transparent will greatly improve privacy protection. By knowing what communications are secure and what are not, users can determine what data should be exchanged under each scenario.

In the case that a second device is to share the same user account with a first device, the master private key stored in the first device is transferred to the second device securely. In a preferred embodiment, the second device generates a pair of temporary private/public keys to facilitate the transfer on top of other secure communication means such as SSL/TLS with server computer. In some embodiments, the first device and the second device can communicate directly with each other. Once the master private key of the user account is received, the master private key will be used to access the data of the user account. In a preferred embodiment, any additional device to use the same user account will require an authorization from an existing device and a notification is sent to all devices of the user account. In addition, any password reset, key recovery and data recovery will trigger a notification to all devices of the user account. Those skilled in art will appreciate that these authorization and notification can significantly improve the security of an user account by allowing the account user be aware of critical changes of the account.

It's understood that the present disclose can be modified for variations. In other embodiments, session key S can be a private key whose public key is used to encrypt other data. In other embodiments, the master private key could be encrypted with a symmetric key. In these embodiments, the encrypted master private key can be stored in the server computer.

When a user forgot the login passphrase as well as losing the master private key, the user loses the account. In order to recover the account, the user must re-authenticate himself/herself against the server to prove that he/she is the person he/she claimed to be. For security reasons, a multi-factor authentication process is required for the server, for example, usually verifying against an email address or text messaging against a mobile number. However, these are not secure factors. To authenticate a user more reliably, in the preferred embodiment, the present disclosure uses a factor of “the peer you know” to perform peer-based authentication to authenticate a user.

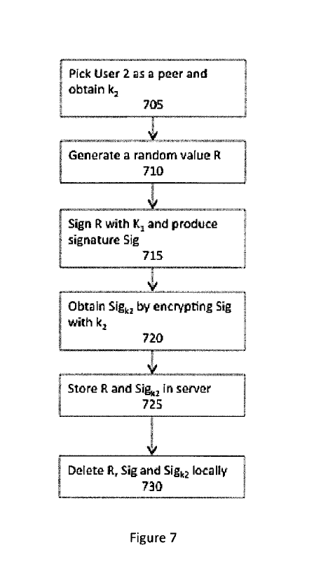

Illustrated in FIG. 7, a method is illustrated of setting up the authentication factor by using a recovery peer for the purpose of recovering account.

At step 705, User 1 picks User 2 as a recovery peer and obtains User 2's public key k₂.

At step 710, User 1's device freshly generates a random value R locally and at step 715, User 1's device signs R with User 1's master private key K₁ 125 and produces a signature of Sig.

At step 720, User 1's device encrypts Sig with k₂ 140 and outputs encrypted signature Sigₖ₂. It's to be understood that User 1's device may also encrypt Sig with a shared symmetric key associated with User 1's and User 2's public keys k₁ and k₂, for example, based on ECIES. In some embodiment, User 1's device may encrypt Sig with a symmetric key of User 2, which is accessible to User 1.

At step 725, User 1's device sends and stores the random value R and the encrypted signature Sigₖ₂ in the server computer 115.

At step 730, User 1's device deletes the random value R, the signature Sig of R and the encrypted signature Sigₖ₂ locally.

Because the random value R is freshly generated locally, the signature Sig produced by K₁ is a secret only known to User 1 device. By deleting the signature Sig, there is no one but User 1 and User 2 can produce signature Sig again. For server computer 115, even though it has the random value R the server does not have the master key K₁, and therefore cannot produce Sig. Instead, it can verify Sig with the stored public key k₁. When User 1 loses the master private key K₁, User 1 can no longer produce Sig to prove to be the owner of the account. Therefore, User 1 has to ask User 2 to reproduce Sig and associate with User 1 back to the account associated with Sig.

In a preferred embodiment, process 700 and process 300 can be used in conjunction such that when User 1 picks a recovery peer, both process 700 and 300 are carried out at the same time. In this embodiment, a user performs a single check to pick a recovery peer. The user can obtain the functionalities of recovering both master private key and account at the same time.

It's understood that User 1 may pick more than one account recovery peer and the account recovery policy may require more than one such peer-based authentication.

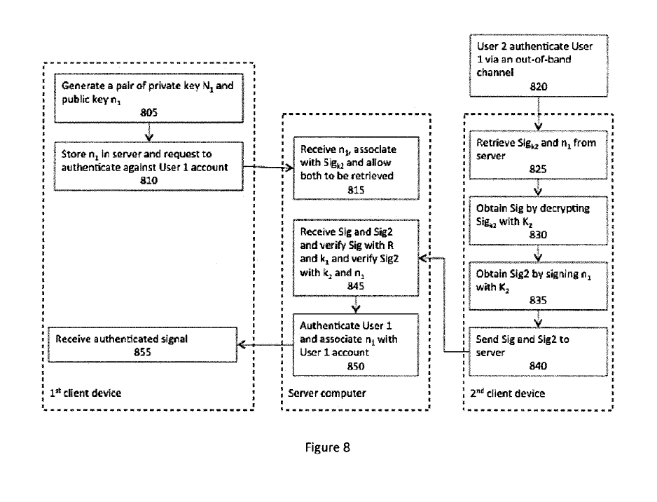

FIG. 8 illustrates process 800 to perform authentication against the server with the factor of “the peer you know” which allows User 1 to recover his/her account, after process 700 has been carried out. In the case of User 1 losing the account because of forgetting password and losing the master private key, in a preferred embodiment, User 1 may carry out a first authentication using some factor known in the art such as an email associated with the account previously stored in the server computer. An additional authentication then is carried out using the factor “the peer you know” described in the process 800.

At step 805, User 1 device generates a new pair of private key N₁ and public key n₁ locally.

At step 810, User 1 device sends n₁ to server computer and requests to authenticate against the lost User 1 account as well as k₁ associated to this account in order to recover this account.

At step 815, once receiving n₁ and the account recovery request, server computer associates n₁ with Sigₖ₂ and allows both to be retrieved by User 2.

At step 820, User 1 initiates an out-of-band exchange with User 2 to request User 2 to help authenticate User 1 against the server computer. In a preferred embodiment, such an out-of-band exchange could be in a form of in-person meeting, live phone/video conversation or some secure communication such that User 2 can authenticate User 1 with high probability. It is to be understood that having User 1 to initiate an exchange with User 2 is also important for improving security, because User 1 must remember that User 2 has been chosen as an account recovery peer previously and that User 2's out-of-band contact information.

At step 825, after User 2 successfully authenticated User 1, User 2 operates User 2 device to retrieve Sigₖ₂ and n₁ from server computer.

At step 830, User 2 device obtains Sig by decrypting Sigₖ₂ with K₂.

At step 835, User 2 device obtains Sig2 by signing n₁ with K₂. By signing n₁ with K₂, User 2 provides a proof of authentication that User 1 associates with n₁ and Sig. In some embodiments, User 2 device may obtain Sig2 by signing n₁ and Sig together. It's to be understood that when exchanging n₁, a verification of n₁ may be performed using any approach known in the art to verify a public key, such as verifying a fingerprint of the public key or a signature, via an out-of-band channel. Such measure is to detect man-in-the-middle attack.

At step 840, User 2 device sends Sig and Sig2 to server computer.

At step 845, after receiving Sig and Sig2, the server computer may verify Sig using the previously stored R and k₁; as well as verify Sig2 by using n₁ and k₂.

At step 850, if both verifications are successful, server computer now has a proof with high confidence that n₁ is from User 1 because User 2 released Sig only after authenticating User 1 and verifying n₁ and that n₁ is associated with User 1. Thus server computer now authenticates User 1 and associates n₁ with User 1 account.

At step 855, User 1 device receives the signal that User 1 has been authenticated successfully.

It's to be understood that process 800 and process 500 can also be used in conjunction. In a preferred embodiment, after successfully authenticated, User 1 device might use the N₁ and n₁ as the new master key pair. In this case, step 505 in process 500 can be skipped.

In a preferred embodiment, when User 1 loses the master private key and request private key recovery, process 800 is not necessary because in process 400, the public key verification between User 1 and User 2 when exchanging each other's public key allows User 2 authenticate User 1 at the same time.

In a preferred embodiment, after successful multi-factor authentication, including at least one peer-based authentication, a user can recover his/her lost account. It's obvious to those skilled in the art that such a “the peer you know” authentication factor may be used as sole authentication factor or in conjunction with other authentication factors. It's to be understood that once used, the relevancy of a previous Sig generated by the original master private key is reduced because User 1 has a new pair of master private and public key. In a preferred embodiment, User 1 may be recommended to pick recovery peers again.

Those skilled in the art will appreciate that the present disclosure makes use of the human authentication and cryptographic property to allow a user to recover his/her account, which has previously established recovery relationship with a peer. Human based authentication is a highly reliable way to authenticate a person in particular in a context of social relationship. If a user chooses familiar and trusted people, such as friends, as recovery peers, the likelihood of an attacker taking over his/her account can be significantly reduced. Using such a peer-based authentication factor, or using social groups by helping and authenticating each other, thus can protect user account better and improve user account security in a network environment. In addition, by allowing a user to choose peers to recover their own accounts, there is no need to depend on centralized user account management. Thus such a social-based security network can be quite self-sufficient.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A social-based cryptographic system that provides secure deposit of a secret data associated with a user account, the system comprising:
a user device, the user device having a memory for storing instructions and a processor for executing the instructions to: derive an encryption key based on a secret provided to the user device to generate a derived encryption key, encrypt the secret data using the derived encryption key to generate a once-encrypted secret data, designate a recovery peer and obtaining a recovery-peer key associated with the recovery peer, and encrypting the once-encrypted secret data using the recovery-peer key to generate a twice-encrypted secret data;
a recovery server to store the twice-encrypted secret data and associate the twice-encrypted secret data with the user account and the recovery peer;
a recovery peer device associated with the recovery peer, the recovery peer device having a memory for storing instructions and a processor for executing the instructions to: generate the recovery-peer key and provide the recovery-peer key to the user device.

2. The social-based cryptographic system of claim 1 wherein the secret data associated with the user account is securely recovered wherein:
recovery peer device having further instructions to obtain the twice-encrypted secret data, decrypt the twice-encrypted secret data using the recovery-peer key to recover the once-encrypted secret data, and transmit the once-encrypted secret data to the user device; and
user device having further instructions to derive the encryption key based on a secret provided to the user device to generate the derived encryption key at the user device, and decrypt the once-encrypted secret data using the derived key to recover the secret data.

3. A method for depositing a secret data of a user account in a cryptographic system to allow for secure recovery of the secret data, the method comprising:
deriving an encryption key based on a secret provided to a user device to generate a derived encryption key at the user device;
designating a recovery peer and obtaining a recovery-peer key associated with the recovery peer;
encrypting the secret data using the derived encryption key and the recovery-peer key to generate an encrypted secret data; and
storing the encrypted secret data at a location remote from the user device.

4. The method of claim 3 wherein encrypting the secret data comprises encrypting the secret data using the derived encryption key to generate a once-encrypted secret data, and encrypting the once-encrypted secret data using the recovery-peer key to generate a twice-encrypted secret data.

5. The method of claim 4 wherein the secret is a password and deriving the derived encryption key uses a password-based key derivation algorithm at the user device.

6. The method of claim 5 further comprising obtaining from a recovery server any one of a salt, an iteration count, and a combination thereof, as an input to the password-based key derivation algorithm.

7. The method of claim 4 further comprising obtaining a symmetric key from the recovery server associated with the user account, and the derived encryption key is comprised of the symmetric key and a key derived from a password-based key derivation algorithm using a password.

8. The method of claim 7 wherein the derived encryption key is comprised of the XOR operation of the symmetric key and the key derived from a password-based key derivation algorithm using the password.

9. The method of claim 3 wherein the recovery-peer key is a public key corresponding to a public/private key pair associated with the recovery peer.

10. The method of claim 3 wherein the recovery-peer key is a symmetric key shared with the recovery peer.

11. The method of claim 10 wherein the recovery-peer key is obtained from the recovery server.

12. The method of claim 3 wherein the recovery peer and the user account have mutually consented to provide secure recovery.

13. The method of claim 3 wherein the location remote from the user device is any one of the recovery peer and the recovery server.

14. The method of claim 13 wherein the encrypted secret data is associated with the user account and the recovery peer.

15. The method of claim 4 further comprising cryptographically signing the twice-encrypted secret data with an identity key associated with the user account.

16. The method of claim 3 wherein the secret data is a private key corresponding to a public/private key pair associated with the user account.

17. A method for securely recovering a secret data of a user account in a cryptographic system, the method comprising:
obtaining an encrypted secret data at a recovery peer device, the encrypted secret data encrypted using a derived encryption key based on a secret and a recovery-peer key of a recovery peer device;
deriving an encryption key based on a secret provided to the user device to generate the derived encryption key at the user device; and
decrypting the encrypted secret data using the recovery-peer key and the derived encryption at the user device to recover the secret data.

18. The method of claim 17 wherein decrypting the secret data comprises:
decrypting the encrypted secret data by the recovery peer device using the recovery-peer key to generate a once-encrypted secret data;
receiving the once-encrypted secret data from the recovery peer device at a user device associated with the user account; and
decrypting the once-encrypted secret data using the derived key to recover the secret data.

19. The method of claim 17 further comprising receiving a request for secret data recovery from a user device at a recovery server; and identifying a recovery peer.

20. The method of claim 18 further comprising transmitting the twice-encrypted secret data to the recovery peer from the recovery server.

21. The method of claim 17 wherein the secret is a password and deriving the derived encryption key uses a password-based key derivation algorithm at the user device.

22. The method of claim 21 further comprising obtaining from a recovery server any one of a salt, an iteration count, and a combination thereof, as an input to the password-based key derivation algorithm.

23. The method of claim 22 further comprising obtaining a symmetric key associated with the user account from the recovery server, and the derived encryption key is comprised of the symmetric key and a key derived from a password-based key derivation algorithm using a password.

24. The method of claim 23 further comprising providing an authentication token to the recovery server from the user device to verify that the user account is associated with the user device, the authentication token generated from the password using the password-based key derivation algorithm at the user device.

25. The method of claim 23 wherein the derived encryption key is comprised of the XOR operation of the symmetric key and the key derived from a password-based key derivation algorithm using the password.

26. The method of claim 17 wherein the recovery-peer key is a private key stored on the recovery peer device corresponding to a public/private key pair of the recovery device.

27. The method of claim 17 further comprising receiving a confirmation associated with the user account through an out-of-band communication that the user account is requesting recovery of the secret data.

28. The method of claim 27 wherein the out-of-band communication can comprise a cryptographic hash associated with a communication channel used by the user device to request secure recovering of the secret data.

29. The method of claim 17 wherein the secret data is a private key corresponding to a public/private key pair associated with the user account.

30. A method of securely recovering a user account without a password using peer-based authentication of ownership of the user account, the method comprising:
generating a random value at a user device associated with the user account and cryptographically signing the random value with a user private key associated with the user account to generate a first signature;
designating a recovery peer and obtaining a recovery key associated with the recovery peer;
encrypting the first signature with the recovery key associated with the recovery peer to generate an encrypted first signature;
storing the random value and the encrypted first signature at a recovery server;
retrieving the encrypted first signature from the recovery server at recovery peer device of the recovery peer;
decrypting the encrypted first signature using the recovery key at a recovery peer device of the recovery peer to generate decrypted first signature;
providing the decrypted first signature to the recovery server; and
verifying the decrypted first signature using a user public key corresponding to the user private key and the random value at the recovery server.

31. The method of claim 30 wherein the recovery key is a public key and decrypting the encrypted first signature uses a recovery private key corresponding to the public key.

32. The method of claim 30 wherein the recovery key is a symmetric key.

33. The method of claim 30 further comprising requesting the recovery peer authenticate ownership of the user account through an out-of-band communication to prevent a man-in-the-middle attack.

34. The method of claim 30 further comprising:
generating a new-identity public key and a new-identity private key;
associating the new-identity public key with the user account by cryptographically signing the new-identity public key with the recovery public key at the recovery peer device to generate a second signature; and
verifying that the second signature belongs to the recovery peer.

35. A method of decoupling a password from secret data secured with the password, the method comprising:
encrypting the secret data with a server key stored at a recovery server; and
permitting access to the server key by a user device by authenticated access using the password.
